(19) United States
(12) Patent Application Publication
(10) Pub. No.: US 2017/0039269 A1
(43) Pub. Date: Feb. 9, 2017

(54) CLIENT INTENT IN AN INTEGRATED SEARCH ENVIRONMENT

(71) Applicants: Paul RAFF, Redmond, WA (US); Xiao HUANG, Redmond, WA (US); Yichao CAI, Redmond, WA (US); Rui MA, Redmond, WA (US); Aidan C. CROOK, Redmond, WA (US); An YAN, Redmond, WA (US); Microsoft Technology Licensing, LLC, Redmond, WA (US)

(72) Inventors: Paul Raff, Redmond, WA (US); Xiao Huang, Bothell, WA (US); Yichao Cai, Beijing (CN); Rui Ma, Beijing (CN); Aidan Crook, Los Altos, CA (US); An Yan, Beijing (CN)

(73) Assignee: Microsoft Technology Licensing, LLC, Redmond, WA (US)

(21) Appl. No.: 15/303,951

(22) PCT Filed: Mar. 26, 2014
(86) PCT No.: PCT/CN2014/074110

§ 371 Date: Oct. 13, 2016

(51) Int. Cl. G06F 17/30; G06N 99/00; G06N 5/04

(52) U.S. Cl. CPC G06F 17/30598; G06F 17/30979; G06N 5/04; G06N 99/005

(57) ABSTRACT

Architecture that operates in combination with an integrated search framework to derive user intent associated with a search query, and then based on the derived intent, choose the search method: a local search on the current local device from which the search is initiated, a non-local search of data sources other than the local device, or both the local search and the non-local search. The query context can be derived to more effectively assess the query intent. The architecture employs predictive models trained with candidate features that enable the prediction of a singular intent (or degree of intent) in the integrated search environment. The models can be trained using historical and real-time features. A classifier is trained using the features. The user intent is then derived based on the classifier output and the search is performed accordingly.

### BACKGROUND

Integrated search environments have become more common for users, where searches are performed on various sources, unlike either the normal web search or the local search on a local user computer. Integrated search environments are typically focused on the web-result aspect of the search, and fail to consider the intent of the user for the search, thereby introducing a significant limitation. For example, if a user wants to start a specific program on the computer, existing approaches do not provide a good user experience when a full page of web results is returned for a query of a local application.

### SUMMARY

The following presents a simplified summary in order to provide a basic understanding of some novel embodiments described herein. This summary is not an extensive overview, and it is not intended to identify key/critical elements or to delineate the scope thereof Its sole purpose is to present some concepts in a simplified form as a prelude to the more detailed description that is presented later.

The disclosed architecture operates in combination with an integrated search framework to derive user intent associated with a search query, and then based on the derived intent, choose the search method: a local search on the current local device from which the search is initiated, a non-local search of data sources other than the local device, or both the local search and the non-local search. The non-local search is performed on any data source other than the local device. Typically, this would be a web search via a web search provider. However, the non-local search can also comprise a personal network (e.g., home) to which the local device is connected, such as a home network, another user device on the personal network, and a different user device in a peer-to-peer connection with the local device. The non-local search can also comprise business intranets, enterprise networks, and other user devices of these private networks. The non-local search can also comprise data sources/devices of other users who give permission to be searched and are accessible via the web, on the private networks, and so on.

Accordingly, the derived intent can be analyzed to obtain an indication as to the source(s) to be searched. For example, the intent can indicate that only the local device data be searched, and not processed through the large web search engines, private business networks, personal networks, etc. Alternatively, the intent can indicate that only one or more of the large web search engines (e.g., Bing™, Yahoo™, etc.) can be employed to return the results. Still alternatively, the intent can indicate that both the local device data and a large web search engine be employed to process the query and return search results. The selectivity capability enables any combination of the aforementioned data sources to be included in the search. In yet another example, the intent can indicate that the search is to be conducted on the local device (e.g., home machine) and all or selected machines/servers of a private business.

Another option is that a search can have a strong intent (e.g., for local) and weak intent (e.g., for non-local). The relative strengths for the two intents can then be used to influence how the results are integrated and/or presented.

If no intent is clearly derived, a default search can be performed, such as the integrated search of both the web search and the local device search, or not search is performed at all. In one embodiment, the default search setting can be configured as the user desires, such as only a local search or only a non-local search, or only a local search and selected non-local data sources, and so on. Additionally, a query that in the past has clearly indicated only a local search can readily be determined to again perform only the search locally.

In another embodiment, a “direct-action” (specific search string) query can be employed. The direct-action query employs keywords that are interpreted by the disclosed architecture to execute the search in predetermined ways. For example, where the query entered for search is a specific file (or filename), the specific query term <filename> or <filename.ext> can be configured or tagged by the user (or learned internally) as a local-search-only term, such that when entered as the search query, the disclosed architecture facilitates the immediate opening of the associated application and the file, rather than returning a list of results the user needs to peruse to find and open the file. This capability obviates the use of shortcut icons to direct activities to the file and hunting down the file in the local data source.

Alternatively, rather than opening the file having that filename, it can be the case that the user is automatically navigated (an auto-navigation function) to the location of that file, such as a local folder that contains the file, or all local folders that contain files having that filename.

This direct-action query can be input in different ways as well, to more easily and quickly ascertain the user intent. For example, a query of “local folder <name>” can readily be computed to be directed to a folder with the name <name>. Alternatively, a query of “local file <filename>” can be readily computed as intent to open that specific file (and the associated folder panel) or auto-navigate to that file location on the local device. Automatically opening the associated folder enhances the user experience since the user now has ready access to other documents/folders/content associated with the file.

In another integrated search scenario, the user can designate, or the architecture can learn, that a query such as “personal network <filename>” is computed to mean the user intent is to include the local device and other personal non-local devices, and accordingly, the search is performed over all personal devices of the user and currently on the user's personal user network and/or at the user's place of work.

In other words, the architecture enables the prediction of a singular intent in an integrated search environment—local data source and non-local data source searches. The architecture predicts when the user intent is solely for non-local searching, solely for local searching, or a combination of both local and non-local searching.

The architecture employs predictive models trained with candidate features that enable the prediction of a singular intent (or degree of intent) in the integrated search environment. The model predictions assist the user's task at hand as the predictions are processed to assist interaction with the integrated search environment. For example, pressing a search button can be configured to always perform an integrated search; however, this capability can be circumvented in instances where a singular intent has been derived, by either performing solely a local search or solely a non-local (e.g., web) search depending on the query context.

The query context defines many different characteristics associated with the query. For example, the query context can include the specific way in which the query was entered such as manually or by NUI gestures (natural user interface), with or without capitalization, language (e.g., English versus French), specific device via which the query was entered, location (e.g.,. geographical, network, etc.) of the device when the query was entered, travel status of the user, hardware/software capabilities of the device from which the query search is initiated, user profile of the user entering the query, one or more applications that were open/not open when the query was entered, the application with which the query is most likely associated, special query terms (or keywords), time of day, day of the week, season, weather conditions, traffic conditions, special events currently ongoing or about to commence, etc.

The features computed for each query can include, but are not limited to, a technology (tech) classifier score, an out-of-context ratio, an auto-navigation ratio, an auto-navigation indicator, a client click-count ratio, and a client click-count indicator. The architecture extends to the use of online features—those that are only available at the time the user interacts with the integrated search environment.

Note that some features used to train the predictive models may be historical in nature (based on past user actions), and some features may be realtime (based on current user actions). Thus, the models can evolve over time. Additionally, the models can evolve or be controlled to evolve to be user-specific. Thus, the user-specific models may be employed on the user device to more effectively assess if the search should be performed solely locally, rather than needing to communicate with an online search engine to make this determination. This capability facilitates an enhanced capability for the user device that is currently disconnected from a network.

A classifier is trained using the features and one or more of various classification techniques such as logistic regression classification where the output of such a regression—a number between zero and one, inclusive) provides a desired response—a number that represented the amount of client intention encapsulated in the query.

The intent can be computed wholly as a zero value (no of intent) or a one value (definite intent). The intent can alternatively be computed in terms of degrees of intent. For example, threshold may be set where below a low threshold indicates no likelihood of intent to search locally, a high threshold indicates a definite intent to search only locally, and between the low threshold and the high threshold, the intent is to search both the locally and non-locally. Choosing to not perform the non-local (e.g., web search) optimizes performance and the end-user experience since network communications can slow down and negatively affect system/device performance.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a predictive system for intent assessment and search selection in accordance with the disclosed architecture.

FIG. 3 illustrates a system where signals can be input and fed back into the predictive models.

FIG. 4 illustrates a results page of both local results and non-local results.

FIG. 5 illustrates a method in accordance with the disclosed architecture.

FIG. 6 illustrates an alternative method in accordance with the disclosed architecture.

FIG. 7 illustrates a block diagram of a computing system that executes client intent in an integrated search environment in accordance with the disclosed architecture.

### DETAILED DESCRIPTION

One aspect of integrated search environments is to understand when the user is searching for something that can be fulfilled via the client only and not just via any web search—this understanding is of client intent.

The disclosed architecture comprises a methodology by which an assessment can be made as to whether client intent exists for a user query, and based on the assessment, the results and/or the user experience are adjusted for the user. For example, the architecture may determine to completely omit performing the web search if the assessment is that the user solely desires local content or local actions (e.g., local application launch). Accordingly, the user experience with the architecture can be improved and the associated products of the user appear to be “smarter”.

The disclosed architecture operates in combination with an integrated search framework to derive user intent associated with a search query, and then based on the derived intent, choose the search method: a local search on the current local device from which the search is initiated, a non-local search of data sources other than the local device, or both the local search and the non-local search. The non-local search is performed on any data source other than the local device. Typically, this would be a web search via a web search provider. However, the non-local search can also comprise a personal network (e.g., home) to which the local device is connected, such as a home network, another user device on the personal network, and a different user device in a peer-to-peer connection with the local device. The non-local search can also comprise business intranets, enterprise networks, and other user devices of these private networks. The non-local search can also comprise data sources/devices of other users who give permission to be searched and are accessible via the web, on the private networks, and so on.

Accordingly, the derived intent can be analyzed to obtain an indication as to the source(s) to be searched. For example, the intent can indicate that only the local device data be searched, and not processed through the large web search engines, private business networks, personal networks, etc. Alternatively, the intent can indicate that only one or more of the large web search engines (e.g., Bing™, Yahoo™, etc.) be employed to return the results. Still alternatively, the intent can indicate that both the local device data and a large web search engine be employed to process the query and return search results. The selectivity capability enables any combination of the aforementioned data sources to be included in the search. In yet another example, the intent can indicate that the search is to be conducted on the local device (e.g., home machine) and all or selected machines/servers of a private business.

If no intent is clearly derived, a default search can be performed, such as the integrated search of both the web search and the local device search, or not search is performed at all. In one embodiment, the default search setting can be configured as the user desires, such as only a local search or only a non-local search, or only a local search and selected non-local data sources, and so on. Additionally, a query that in the past has clearly indicated only a local search can readily be determined to again perform only the search locally.

In another embodiment, a “direct-action” (e.g., a specific search string) query can be employed. The direct-action query can employ keywords that are interpreted by the disclosed architecture to execute the search in predetermined ways. For example, where the query entered for search is a specific file (or filename), the specific query term <filename> or <filename.ext> can be configured or tagged by the user (or learned internally) as a local-search-only term, such that when entered as the search query, the disclosed architecture facilitates the immediate opening of the associated application and the file, rather than returning a list of results the user needs to peruse to find and open the file. This capability obviates the use of shortcut icons to direct activities to the file and hunting down the file in the local data source.

Alternatively, rather than opening the file having that filename, it can be the case that the user is automatically navigated (an auto-navigation function) to the location of that file, such as a local folder that contains the file, or all local folders that contain files having that filename.

This direct-action query can be input in different ways as well, to more easily and quickly ascertain the user intent. For example, a query of “local folder <name>” can readily be computed to be directed to a folder with the name <name>. Alternatively, a query of “local file <filename>” can be readily computed as intent to open that specific file (and the associated folder panel) or auto-navigate to that file location on the local device. Automatically opening the associated folder enhances the user experience since the user now has ready access to other documents/folders/content associated with the file.

In another integrated search scenario, the user can designate, or the architecture can learn, that a query such as “personal network <filename>” is computed to mean the user intent is to include the local device and other personal non-local devices, and accordingly, the search is performed over all personal devices of the user and currently on the user's personal user network and/or at the user's place of work.

In other words, the architecture enables the prediction of a singular intent in an integrated search environment—local data source and non-local data source searches. The architecture predicts when the user intent is solely for non-local searching, solely for local searching, or a combination of both local and non-local searching.

The architecture employs predictive models trained with candidate features that enable the prediction of a singular intent (or degree of intent) in the integrated search environment. The model predictions assist the user's task at hand as the predictions are processed to assist interaction with the integrated search environment. For example, pressing a search button can be configured to always perform an integrated search; however, this capability can be circumvented in instances where a singular intent has been derived, by either performing solely a local search or solely a non-local (e.g., web) search depending on the query context.

The query context defines many different characteristics associated with the query. For example, the query context can include the specific way in which the query was entered such as manually or by NUI gestures (natural user interface), with or without capitalization, language (e.g., English versus French), specific device via which the query was entered, location (e.g.,. geographical, network, etc.) of the device when the query was entered, travel status of the user, hardware/software capabilities of the device from which the query search is initiated, user profile of the user entering the query, one or more applications that were open/not open when the query was entered, the application with which the query is most likely associated, special query terms (or keywords), time of day, day of the week, season, weather conditions, traffic conditions, special events currently ongoing or about to commence, etc.

User interaction with the local device can be gesture-enabled, whereby the user employs one or more gestures for interaction. For example, the gestures can be natural user interface (NUI) gestures. NUI may be defined as any interface technology that enables a user to interact with a device in a “natural” manner, free from artificial constraints imposed by input devices such as mice, keyboards, remote controls, and the like. Examples of NUI methods include those methods that employ gestures, broadly defined herein to include, but not limited to, tactile and non-tactile interfaces such as speech recognition, touch recognition, facial recognition, stylus recognition, air gestures (e.g., hand poses and movements and other body/appendage motions/poses), head and eye tracking, voice and speech utterances, and machine learning related at least to vision, speech, voice, pose, and touch data, for example.

NUI technologies include, but are not limited to, touch sensitive displays, voice and speech recognition, intention and goal understanding, motion gesture detection using depth cameras (e.g., stereoscopic camera systems, infrared camera systems, color camera systems, and combinations thereof), motion gesture detection using accelerometers/gyroscopes, facial recognition, 3D displays, head, eye, and gaze tracking, immersive augmented reality and virtual reality systems, all of which provide a more natural user interface, as well as technologies for sensing brain activity using electric field sensing electrodes (e.g., electro-encephalograph (EEG)) and other neuro-biofeedback methods.

The features computed for each query can include, but are not limited to, a technology (tech) classifier score, an out-of-context ratio, an auto-navigation ratio, an auto-navigation indicator, a client click-count ratio, and a client click-count indicator. The architecture extends to the use of online features—those that are only available at the time the user interacts with the integrated search environment.

Technology classifier score can be a score that ranges between zero and one, inclusive, and that operates as the technical classification for the query. A higher score indicates that the query has more of a technical connotation to it.

The out-of-context ratio is the number of queries performed in the integrated search environment compared to the number of queries performed in the web-only search environment. A query with a higher ratio indicates the query is searched more often in the integrated environment, which indicates that the query is more likely to have client intent.

The auto-navigation ratio is the number of times the query performs an auto-navigation event compared to the number of times the query results in an integrated search page. In one implementation of a user interface search control, certain queries (e.g., Control Panel) result in an auto-navigation event, where the user is taken immediately to the desired destination (the Control Panel program, in this case) rather than an integrated search results page.

The auto-navigation indicator indicates the query potentially can be used in an auto-navigation event. The indicator can be a “one” value (or the like) if and only if the auto-navigation ratio is greater than zero; otherwise, the indicator is a “zero” value (or the like).

The client click-count ratio: in an integrated search results page, links to content that is client-based may be shown, for example, links to applications, programs, and/or specific files. If a user clicks on this content more often than web results, for certain queries, this indicates the query has more associated client intent.

The client click-count indicator indicates that the query resulted in a click count on client content in the integrated search results page, at least once. The indicator is a “one” value (or the like) if and only if the client click-count ratio is greater than a “zero” value (or the like), and an indicator value of zero, otherwise.

Using any combination of the above features, and possibly other features as desired, the classifier (classification component) may be trained using various classification techniques. Other classification algorithms that can be employed include, but are not limited to, decision trees, weighted decision forests, and general statistical algorithms.

Note that some features used to train the predictive models may be historical in nature (based on past user actions), and some features may be realtime (based on current user actions). Thus, the models can evolve over time. Additionally, the models can evolve or be controlled to evolve to be user-specific. Thus, the user-specific models may be employed on the user device to more effectively assess if the search should be performed solely locally, rather than needing to communicate with an online search engine to make this determination. This capability facilitates an enhanced capability for the user device that is currently disconnected from a network.

A classifier is trained using the features and one or more of various classification techniques such as logistic regression classification where the output of such a regression—a number between zero and one, inclusive) provides a desired response—a number that represented the amount of client intention encapsulated in the query.

The intent can be computed wholly as a zero value (no of intent) or a one value (definite intent). The intent can alternatively be computed in terms of degrees of intent. For example, threshold may be set where below a low threshold indicates no likelihood of intent to search locally, a high threshold indicates a definite intent to search only locally, and between the low threshold and the high threshold, the intent is to search both the locally and non-locally. Choosing to not perform the non-local search (e.g., web search) optimizes performance and the end-user experience since network communications can slow down and negatively affect system/device performance.

The level of intent can be used to set time-out threshold or wait requirements for obtaining results. For example, the user may be willing to wait twice as long for the web result service to respond if a web intent score was 0.8 instead of 0.4. The intent score thereby provides a way of specifying both the probability that results will be obtained from a specific source, as well as enabling the tuning of system performance.

Utilizing the predictions of the models improves the user experience and tasks at hand as the user interacts with the integrated search environment. For example, pressing the search button on search initiator button (e.g., Search Charm™ in a Windows™ operating system) may be programmed to always perform an integrated search. However, this programmed operation or function may be circumvented in instances where the detected singular intent is infers that the search be performed either solely as a local search or solely as a non-local search (e.g., web search) and depending on the context.

The query string itself may be all that is needed to perform in either a local or non-local setting. For example, the query string may be employed to infer a singular intent for local search, and/or realtime features may be employed to infer singular intent for non-local search (e.g., a web search).

Reference is now made to the drawings, wherein like reference numerals are used to refer to like elements throughout. In the following description, for purposes of explanation, numerous specific details are set forth in order to provide a thorough understanding thereof It may be evident, however, that the novel embodiments can be practiced without these specific details. In other instances, well known structures and devices are shown in block diagram form in order to facilitate a description thereof The intention is to cover all modifications, equivalents, and alternatives falling within the spirit and scope of the claimed subject matter.

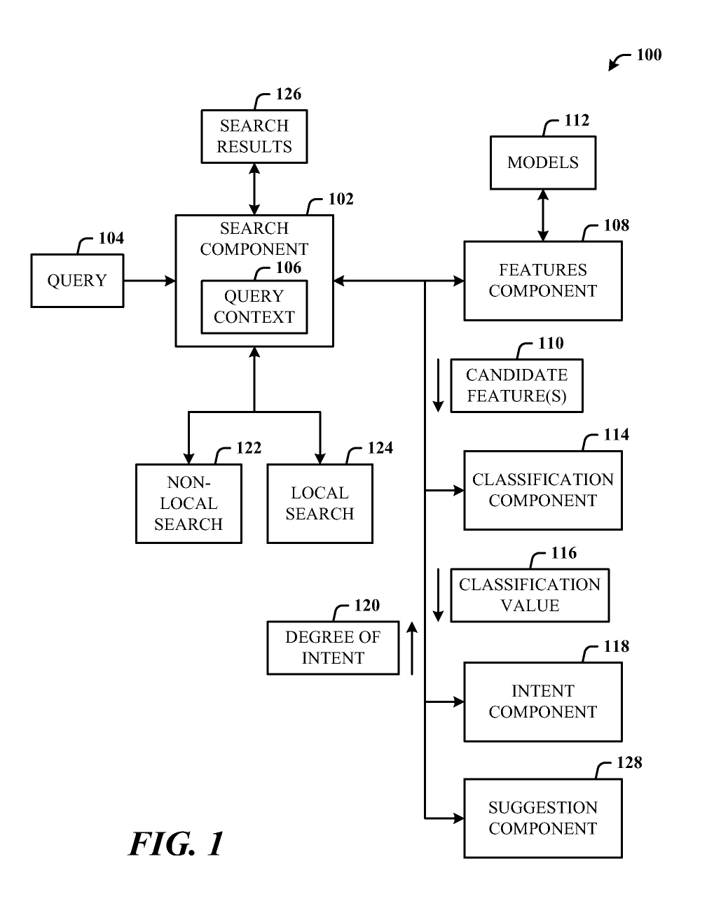

FIG. 1 illustrates a system 100 in accordance with the disclosed architecture. The system 100 can include a search component 102 configured to receive a query 104 as part of an integrated search process and to receive query context 106 of the query. The query context 106 relates to at least one of a device (e.g., handheld, phone, portable, desktop, etc.) from which the query is input, location (e.g., geographical, network, etc.) of the device, or application activity (e.g., application already open, search initiated from within an application, the type of application(s) open, the currently active application (in the foreground), etc.) of the device, and so on.

A features component 108 can be configured to obtain candidate features 110 from predictive models 112 as relate to the query 104 and/or the query context 106. A classification component 114 can be configured to generate a classification value 116 for the query 104 based on the candidate features 110. The classification component 114 can perform classification using any one or more of different algorithms, including, but not limited to, a regression algorithm, hierarchical classifier algorithm that first predicts whether a query has client intent; if yes, then predicts the query subcategory (e.g., file, settings, applications, etc.).

An intent component 118 can be configured to identify a degree of intent 120 based on the classification value 116. The search process is directed by the search component 102 to a non-local search 122 (e.g., web, network-based) or a local search 124 based on the degree of intent 120.

The search process is performed as both the local search 124 and the non-local search 122 to obtain overall results 126. The overall results 126 can be adjusted to show only relevant results related to the degree of intent 120. The intent component 118 computes the degree of intent 120 as relates to non-local content of data sources other than the local device (or data source), local content of the local device, a local file of the local device, and a local application of the local device.

The candidate features 110 can include any one or more features. For example, the candidate features 110 can include a technology classifier score that indicates a technical implication to the query. The candidate features 110 can include an out-of-context feature that defines compares information from single search environments and integrated search environments to identify single search queries. The candidate features 110 include auto-navigation metrics associated with auto-navigation events potential of the query to be used in an auto-navigation event. The candidate features 110 can include click-count metrics associated with click-count activities as relate to local content.

The features and/or user triggers (actions provided by the user to the system) can include QAS (quality segmentation score), client or non-client region click probability, a white list of operating system commands, regular expression having certain patterns (e.g., *.pdf, %appdata%, etc.), and so on.

The system 100 can, optionally, further comprise a suggestion component 128 that proactively suggests content. The suggestion component 128 can be configured to operate separately (override), in cooperation with the classification component 114, or not at all for any given query. For example, the suggestion component 128 can suggest local documents or web content that may be relevant to the user given the current time or context. The suggestion capability can be based on a generated query, but need not be limited to such, and can be based on the most common queries for the user over a period of time (e.g., in the past twenty-four hours), the location of the user (e.g., work, home, etc.), common queries for all device users (e.g., Windows™), search engine users (e.g., Bing™), social network users, enterprise users, etc.

It can be the case that the suggestion component 128 overrides the classification component 114 such that only results from the suggestion component are utilized. The override capability can be enabled based on the criteria such as the context, current time, etc. Thus, the classification score output by the classification component 114 is discarded or used in some other desired way. It can also be the case that once a decision is made to use the suggestion component 128, the operation of the classification component 114 is idled so as to not perform computations that may require resources.

When operating in combination with the classification component 114, once the classification score indicates a high degree of local intent, for example, the suggestion component 128 can then be employed to then suggest the content previously accessed or relevant to a most recent local search session, for example.

The suggestion component 128, which proactively suggests content, need not be triggered on the query (which is a pre-requisite for the query-classification system). It can be the case that since the two components (114 and 128) may trigger on different events (suggesting content at constant time intervals, or other non-query events such as when the user returns to the home screen or opens the search box), these components (114 and 128) neither have to compete nor would one system override the other. A proactive system can utilize the classification component 114 to provide an intent score based on other (e.g., the user's previous, or otherwise relevant to the current context) queries and their classified intents. The suggestion component 128 would therefore work on top of the classification component 114, and not need to compete with it.

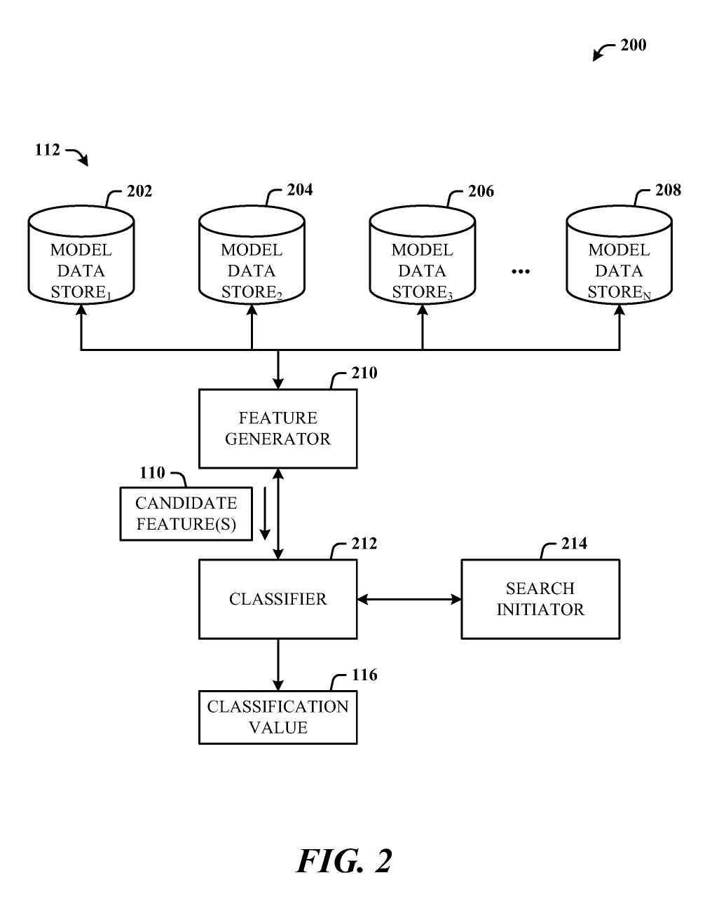

FIG. 2 illustrates a predictive system 200 for intent assessment and search selection in accordance with the disclosed architecture. The system 200 comprises the predictive models 112, which can comprise a first model 202 (e.g., a technology classifier data store), a second model 204 (e.g., a query statistics data store), a third model 206 (e.g., click information), and other models 208, as desired. The third model 206 (e.g., click information) can operate to provide the click-count metrics of client click-count ratio and client click-count indicator, for example.

A feature generator 210 (similar to the feature component 108) operates to select the candidate features 110 from the predictive models 112 as relate to the query 104 and/or query context 106. The candidate features 110 are then input to a classifier 212 (similar to the classification component 114) to process the candidate features 110 and generate the classification value 116 utilized to determine the degree of intent 120.

A search initiator 214 is depicted as an input to the classifier 212. In one embodiment, the search initiator 214 is a specific type of signal that influences the classifier 212. For example, the search initiator 214 can be a software control configured to always indicate to the integrated search environment to perform the search as both a local search and as a non-local search (e.g., web).

It can also be the case that the candidate features 110, as processed by the classifier 212, indicate a high likelihood that the user intent (query intent) is to perform only the local search. Thus, the dual search (local and non-local) configured to be automatically initiated by activation of the search initiator 214, is overridden by the degree of intent derived from the classification score 116. Whatever the programmed purpose or function of the search initiator 214, the purpose or function can be configured to be overridden with a suitably-defined difference value, as compared to the classification value 116 derived from the classifier 212. For example, if the derived intent is computed to have at least an eighty-five percent likelihood of local-only search, as indicated by the classification value 116, the programmed function of the initiator 214 can be overridden (or ignored).

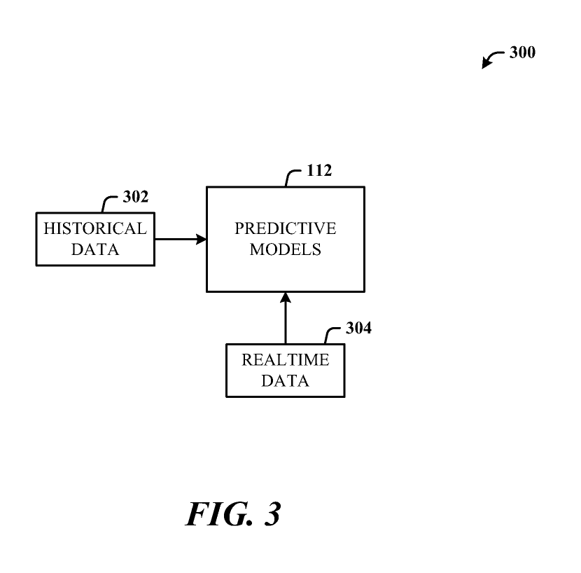

FIG. 3 illustrates a system 300 where signals can be input and fed back into the predictive models 112. The models 112 can be developed at least using historical data 302 obtained from other users. The historical data 302 can be parsed to the purposes of the specific models. For example, click information can be utilized in one model but not another, and auto-navigation data can be employed in one model but no other models. Additionally, realtime data 304 of the current user can be fed back into the models 112 or specific models. Still further, realtime data of other users can be fed back into the models 112 to impact the selection of the candidate features from the models.

The models 112 can be hosted online for utilization by commonly-known larger search providers. It is within contemplation of the disclosed architecture that the models 112 or copies thereof can be hosted locally as well, such as on a personal network or personal device, and updated as desired. Updates on both hosted model sets can be synchronized as desired so that the locally hosted models update the online models and the online models update the local models.

In an enhanced implementation, the models 112 can be evolved to be customized to the user. Thus, in the online hosted set, the models 112 are specific to the user and are updated based only on user search activity and other user device/application activities.

It is to be understood that in the disclosed architecture, certain components may be rearranged, combined, omitted, and additional components may be included. Additionally, in some embodiments, all or some of the components are present on the client, while in other embodiments some components may reside on a server or are provided by a local or remote service.

The disclosed architecture can optionally include a privacy component (not shown) that enables the user to opt in or opt out of identifying and/or exposing personal information. The privacy component enables the authorized and secure handling of user information, such as tracking information, as well as personal information that may have been obtained, is maintained, and/or is accessible. The user can be provided with notice of the collection of portions of the personal information and the opportunity to opt-in or opt-out of the collection process. Consent can take several forms. Opt-in consent can impose on the user to take an affirmative action before the data is collected. Alternatively, opt-out consent can impose on the user to take an affirmative action to prevent the collection of data before that data is collected.

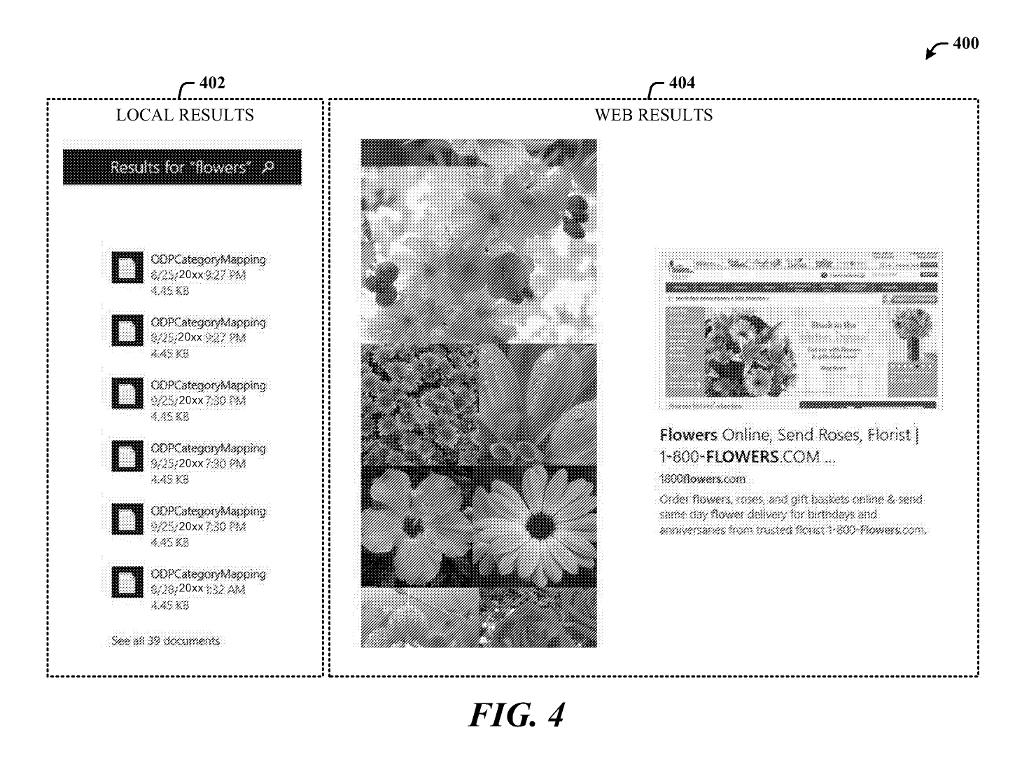

FIG. 4 illustrates a results page 400 of both local results 402 and non-local results 404. The intent derived from a “flowers” query can influence not only whether the search is local and/or non-local, but also the way in which the results are presented. In this page 400, the results are separated: the local results 402 are presented/listed on the left, and the non-local (e.g., web) results 404 are presented/listed on the right. Additionally, the results can be ranked in each of the result sets: local results 402 and non-local results 404. Still further, the number of results listed can be dependent on the amount of display space.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

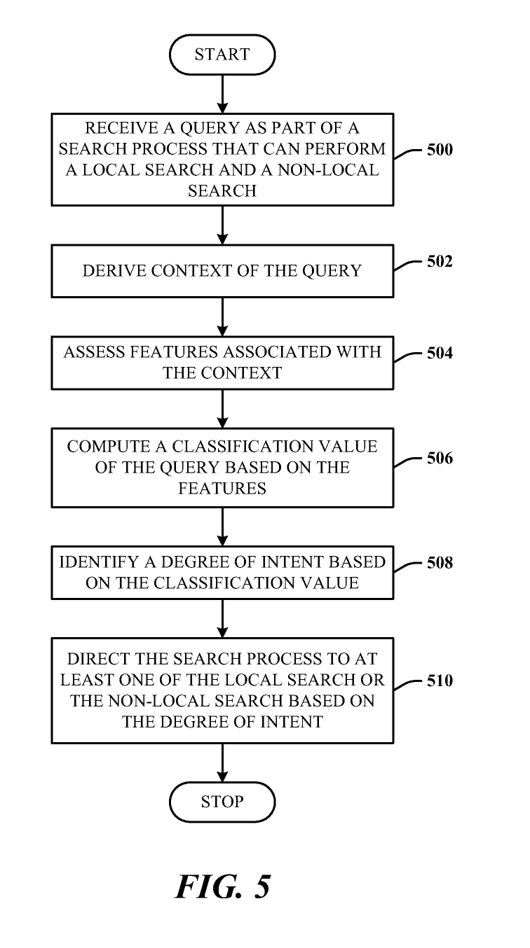

FIG. 5 illustrates a method in accordance with the disclosed architecture. At 500, a query is received as part of a search process that can perform a local search and a non-local search. At 502, context of the query is derived. At 504, features associated with the context are assessed. At 506, a classification value of the query is computed based on the features. At 508, a degree of intent is identified based on the classification value. At 510, the search process is directed to at least one of the local search or the non-local search based on the degree of intent.

The method can further comprise adjusting the search results based on the degree of intent. In other words, the search results can be obtained solely from the local search based on the degree of intent. Alternatively, it can also be the case that the search process involves searching both the local content and the non-local content (e.g., web); however, based on the degree of intent indicating only local search, only the results of the local will be presented (the non-local search results will be ignored). The method can further comprise obtaining the features from predictive models to identify the degree of intent. The method can further comprise applying an out-of-context feature to determine when a query is most frequently associated with the local search. Thus, if a specific search term or string frequently indicates intent to search the local device or local data store, it can be inferred with a high degree of likelihood that the same query in the future will again indicate a local search.

The method can further comprise overriding a programmed search function and choosing a different search process based on the degree of intent. The method can further comprise directing the search process based on the degree of intent as computed according to a query string or realtime features. For example, if the query string can be interpreted with a high degree of confidence to indicate a specific intent, the search process is then directed accordingly. If the realtime features can be interpreted with a high degree of confidence to indicate a specific intent, again, the search process can be directed accordingly. For example, the realtime feature or features (e.g., geolocation information or network information) indicate the user may be at home, it may be inferred directly that the search will be a local-only search.

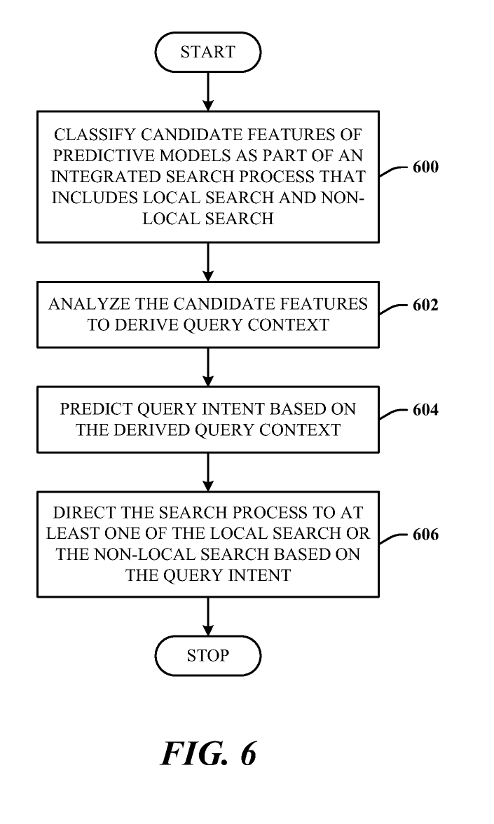

FIG. 6 illustrates an alternative method in accordance with the disclosed architecture. The method can be embodied as a computer-readable physical storage medium comprising computer-executable instructions that when executed by a microprocessor, cause the microprocessor to perform the following acts.

At 600, candidate features of predictive models are classified as part of an integrated search process that includes local search and non-local search. At 602, the candidate features are analyzed to derive query context. At 604, query intent is predicted based on the derived query context. At 606, the search process is directed to at least one of the local search or the non-local search based on the query intent.

The method can further comprise an act of deriving the query intent based on features associated with at least one of out-of-context, technology (e.g., technology classifier score), auto-navigation metrics, or client click-count metrics. The method can further comprise an act of directing the search process to at least one of non-local content, local content, a local file, or a local application based on the query intent and query context.

The method can further comprise an act of directing the search process based on the query intent as computed according to a query string or a realtime feature. The method can further comprise an act of overriding a programmed search function and choosing a different search process based on the query intent.

As used in this application, the terms “component” and “system” are intended to refer to a computer-related entity, either hardware, a combination of software and tangible hardware, software, or software in execution. For example, a component can be, but is not limited to, tangible components such as a microprocessor, chip memory, mass storage devices (e.g., optical drives, solid state drives, and/or magnetic storage media drives), and computers, and software components such as a process running on a microprocessor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

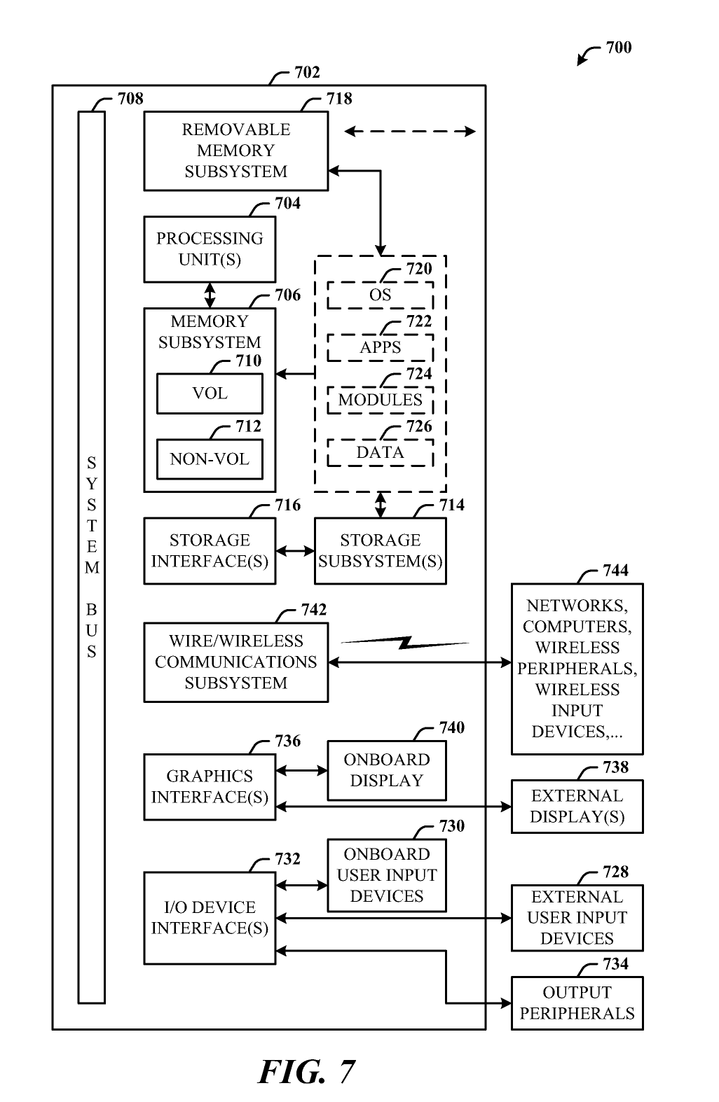

Referring now to FIG. 7, there is illustrated a block diagram of a computing system 700 that executes client intent in an integrated search environment in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 7 and the following description are intended to provide a brief, general description of the suitable computing system 700 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 700 for implementing various aspects includes the computer 702 having microprocessing unit(s) 704 (also referred to as microprocessor(s) and processor(s)), a computer-readable storage medium such as a system memory 706 (computer readable storage medium/media also include magnetic disks, optical disks, solid state drives, external memory systems, and flash memory drives), and a system bus 708. The microprocessing unit(s) 704 can be any of various commercially available microprocessors such as single-processor, multi-processor, single-core units and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 702 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 706 can include computer-readable storage (physical storage) medium such as a volatile (VOL) memory 710 (e.g., random access memory (RAM)) and a non-volatile memory (NON-VOL) 712 (e.g., ROM, EPROM, EEPROM, etc.). A basic input/output system (BIOS) can be stored in the non-volatile memory 712, and includes the basic routines that facilitate the communication of data and signals between components within the computer 702, such as during startup. The volatile memory 710 can also include a high-speed RAM such as static RAM for caching data.

The system bus 708 provides an interface for system components including, but not limited to, the system memory 706 to the microprocessing unit(s) 704. The system bus 708 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 702 further includes machine readable storage subsystem(s) 714 and storage interface(s) 716 for interfacing the storage subsystem(s) 714 to the system bus 708 and other desired computer components and circuits. The storage subsystem(s) 714 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) 716 can include interface technologies such as EIDE, ATA, SATA, and IEEE 1394, for example.

One or more programs and data can be stored in the memory subsystem 706, a machine readable and removable memory subsystem 718 (e.g., flash drive form factor technology), and/or the storage subsystem(s) 714 (e.g., optical, magnetic, solid state), including an operating system 720, one or more application programs 722, other program modules 724, and program data 726.

The operating system 720, one or more application programs 722, other program modules 724, and/or program data 726 can include items and components of the system 100 of FIG. 1, items and components of the system 200 of FIG. 2, items and components of the system 300 of FIG. 3, items and elements of the results page 400 of FIG. 4, and the methods represented by the flowcharts of FIGS. 5 and 6, for example.

Generally, programs include routines, methods, data structures, other software components, etc., that perform particular tasks, functions, or implement particular abstract data types. All or portions of the operating system 720, applications 722, modules 724, and/or data 726 can also be cached in memory such as the volatile memory 710 and/or non-volatile memory, for example. It is to be appreciated that the disclosed architecture can be implemented with various commercially available operating systems or combinations of operating systems (e.g., as virtual machines).

The storage subsystem(s) 714 and memory subsystems (706 and 718) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 702, and include volatile and non-volatile internal and/or external media that is removable and/or non-removable. For the computer 702, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 702, programs, and data using external user input devices 728 such as a keyboard and a mouse, as well as by voice commands facilitated by speech recognition. Other external user input devices 728 can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the computer 702, programs, and data using onboard user input devices 730 such a touchpad, microphone, keyboard, etc., where the computer 702 is a portable computer, for example.

These and other input devices are connected to the microprocessing unit(s) 704 through input/output (I/O) device interface(s) 732 via the system bus 708, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 732 also facilitate the use of output peripherals 734 such as printers, audio devices, camera devices, and so on, such as a sound card and/or onboard audio processing capability.

One or more graphics interface(s) 736 (also commonly referred to as a graphics processing unit (GPU)) provide graphics and video signals between the computer 702 and external display(s) 738 (e.g., LCD, plasma) and/or onboard displays 740 (e.g., for portable computer). The graphics interface(s) 736 can also be manufactured as part of the computer system board.

The computer 702 can operate in a networked environment (e.g., IP-based) using logical connections via a wired/wireless communications subsystem 742 to one or more networks and/or other computers. The other computers can include workstations, servers, routers, personal computers, microprocessor-based entertainment appliances, peer devices or other common network nodes, and typically include many or all of the elements described relative to the computer 702. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 702 connects to the network via a wired/wireless communication subsystem 742 (e.g., a network interface adapter, onboard transceiver subsystem, etc.) to communicate with wired/wireless networks, wired/wireless printers, wired/wireless input devices 744, and so on. The computer 702 can include a modem or other means for establishing communications over the network. In a networked environment, programs and data relative to the computer 702 can be stored in the remote memory/storage device, as is associated with a distributed system. It will be appreciated that the network connections shown are exemplary and other means of establishing a communications link between the computers can be used.

The computer 702 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a search component configured to receive a query as part of an integrated search process and to receive query context of the query;
a classification component configured to generate a classification value for the query based on the candidate features of predictive models;
an intent component configured to identify a degree of intent based on the classification value, wherein the search process is directed by the search component based on the degree of intent, to at least one of a local search or a non-local search; and
at least one microprocessor configured to execute computer-executable instructions in a memory associated with the search component, the classification component, and the intent component.

2. The system of claim 1, wherein the search process is performed as both the local search and the non-local search to obtain overall results, and the overall results are adjusted to show only relevant results related to the degree of intent.

3. The system of claim 1, wherein the intent component computes the degree of intent as relates to non-local content, local content, a local file, and a local application.

4. The system of claim 1, further comprising a features component configured to obtain the candidate features related to the query and query context.

5. The system of claim 1, further comprising a suggestion component that operates separately or in cooperation with the classification component to suggest local content or web content relevant to the query context.

6. A method, comprising acts of:
receiving a query as part of a search process that can perform a local search and a non-local search;
deriving context of the query;
assessing features associated with the context;
computing a classification value of the query based on the features;
identifying a degree of intent based on the classification value;
directing the search process to at least one of the local search or the non-local search based on the degree of intent; and
configuring a microprocessor to execute instructions in a memory associated with the acts of receiving, deriving, assessing, computing, identifying, and directing.

7. The method of claim 6, further comprising adjusting the search results based on the degree of intent.

8. The method of claim 6, further comprising obtaining the features from predictive models to identify the degree of intent.

9. The method of claim 6, further comprising applying an out-of-context feature to determine when a query is most frequently associated with the local search.

10. The method of claim 6, further comprising overriding a programmed search function and choosing a different search process based on the degree of intent.
